(19) United States
(12) Patent Application Publication
(10) Pub. No.: US 2014/0280469 A1
(43) Pub. Date: Sep. 18, 2014

(54) METHOD AND APPARATUS FOR REMOTE MANAGEMENT OF COMPUTER SYSTEM USING HANDHELD DEVICE

(71) Applicant: AMERICAN MEGATRENDS, INC., Norcross, GA (US)

(72) Inventors: Jason Messer, Jefferson, GA (US); Varadachari Sudan Ayanam, Suwanee, GA (US); Samvinesh Christopher, Suwanee, GA (US)

(73) Assignee: AMERICAN MEGATRENDS, INC., Norcross, GA (US)

(21) Appl. No.: 13/803,916

(22) Filed: Mar. 14, 2013

(51) Int. Cl. H04L 29/06

(52) U.S. Cl. CPC H04L 67/42
USPC 709/203

(57) ABSTRACT

Certain aspects of the present disclosure are directed to a mobile IPMI remote management application program. The application program is executed on a processor of a handheld device and configured to: (a) display a first user interface on the handheld device, (b) receive a user input through the first user interface, (c) determine an IPMI request message and a target baseboard management controller (BMC) based on the user input, and (d) construct the request message and transmit the request message to the target BMC through a network. The application program includes (a) a management module, (b) a user interface module, (c) a message module, (d) a network module, and (f) a data module. The application program is also configured to: (a) encapsulate the request message in network packet, (b) determine a network address of the target BMC, and (c) transmit the network packet to the network.

### FIELD

The present disclosure generally relates to remote management control of a computer system, and more particularly to remote management of computer system using handheld device.

### BACKGROUND

A system administrator typically is required to stay close to a computer connected to a network in order to monitor and manage computer systems through baseboard management controllers (BMCs). It is, however, difficult for a system administrator to monitor and maintain the computer systems when he is not in the office and has no access to a networked computer.

Handheld devices such as Smartphones and tablets with network access become more and more common nowadays. Using handheld devices to remotely manage computer systems through baseboard management controllers (BMCs) may become possible.

Therefore, unaddressed needs exist in the art to address the aforementioned deficiencies and inadequacies.

### SUMMARY

Certain aspects of the present disclosure are directed to a mobile IPMI remote management application. The mobile IPMI remote management application includes an application program executed on a processor of a handheld device and configured to: (a) display a first user interface on the handheld device, (b) receive a user input through the first user interface, (c) determine an IPMI request message and a target baseboard management controller (BMC) based on the user input, and (d) construct the request message and transmit the request message to the target BMC through a network. The application program is also configured to: (a) encapsulate the request message in the at least one first network packet, (b) determine a network address of the target BMC, and (c) transmit the at least one first network packet to the network address through the network. The application program is further configured to: (a) receive at least one second network packet encapsulating an IPMI response message, (b) extract the IPMI response message from the second network packets, (c) extract response data from the IPMI response message, and (d) display a second interface on the handheld device, the second interface having the response data.

In certain embodiments, the request message requests the target BMC to perform at least one management function on a computer system managed by the target BMC, and the request message requests the target BMC to perform a management function on at least one management device of the computer system. The management device includes at least one of: a IPM Device, a Sensor Device, a SDR Repository Device, a SEL Device, a FRU Inventory Device, an Event Receiver Device, an Event Generator Device, an Application Device 164, a PEF Device, an Alert Processing Device 162, and a Chassis Device.

In certain embodiments, the application program includes: (a) a management module, (b) a user interface module, (c) a message module, and (d) a network module. The management module is configured to: (a) obtain information of the user input from the user interface module, (b) determine the IPMI request message in accordance with the information, (c) retrieves the request data from the information, (d) instruct the message module to construct the IPMI request message with the request data, (e) obtain the constructed IPMI request message from the message module, and (f) transmit the constructed request message to the network module with a network address of the target BMC. The user interface module is configured to: (a) generate the first interface and display the first interface on the handheld device, and (b) receive the user input through the first interface. The message module is configured to: (a) receive a request indication and the request data, and (b) construct the IPMI request message containing the request data in accordance with the request indication.

In certain embodiments, the network module is configured to: (a) receive the IPMI request message and a first network address, (b) encapsulate the IPMI request message in at least one first network packet addressed to a first network address, and (c) transmit the at least one first network packet to a network. The network module is also configured to: (a) receive at least one second network packet encapsulating an IPMI response message, (b) extract the IPMI response message from the second network packet, and (c) send the IPMI response message to the management module. The management module is also configured to: (a) send the response message to the message module to extract response data, and (b) send the response data to the user interface module. The user interface module is also configured to display a second user interface having the response data.

In certain embodiments, the application program includes a data module, and the data module is configured to: (a) receive record data, and (b) store the record data in a storage area of the data module. In certain embodiments, the application program is running on an Android operating system.

Certain aspects of the present disclosure are directed to a method of IPMI remote management. The method includes: (a) displaying a first user interface of an application program on a handheld device, (b) receiving a user input through the first user interface, (c) determining an IPMI request message and a target baseboard management controller (BMC) based on the user input, and constructing the request message and transmit the request message to the target BMC through a network.

Certain aspects of the present disclosure are directed to a non-transitory computer storage medium. The non-transitory computer storage medium stores computer-executable instructions, when the computer-executable instructions are executed by a processor of a handheld device, cause the processor to: (a) display a first user interface on the handheld device, (b) receive a user input through the first user interface, (c) determine an IPMI request message and a target baseboard management controller (BMC) based on the user input, and (d) construct the request message and transmit the request message to the target BMC through a network.

These and other aspects of the present disclosure will become apparent from the following description of the preferred embodiment taken in conjunction with the following drawings and their captions, although variations and modification therein may be affected without departing from the spirit and scope of the novel concepts of the disclosure.

### BRIEF DESCRIPTION OF THE DRAWINGS

The accompanying drawings illustrate one or more embodiments of the disclosure and, together with the written description, serve to explain the principles of the disclosure. Wherever possible, the same reference numbers are used throughout the drawings to refer to the same or like elements of an embodiment, and wherein:

FIG. 1 is a conceptual illustration of a networked computer system 100 according to one embodiment of the present disclosure;

FIG. 2 is a block diagram schematically showing the architecture of a handheld computing device in accordance with certain embodiments of the present disclosure;

FIG. 3A shows an exemplary connection interface according to certain embodiments of the present disclosure;

FIG. 3B illustrates a touch screen soft keyboard according to one embodiment of the present disclosure;

FIG. 4 shows an exemplary functions selection interface according to one embodiment of the present disclosure;

FIG. 5 shows an exemplary power management interface according to one embodiment of the present disclosure;

FIG. 6A shows an exemplary sensor data display interface according to one embodiment of the present disclosure;

FIG. 6B illustrates an exemplary detail display interface according to one embodiment of the present disclosure;

FIG. 7 illustrates a system event log screen according to one embodiment of the present disclosure; and

FIG. 8 illustrates a Field Replaceable Unit (FRU) screen according to one embodiment of the present disclosure.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, “plurality” means two or more.

As used herein, the terms “comprising,” “including,” “carrying,” “having,” “containing,” “involving,” and the like are to be understood to be open-ended, i.e., to mean including but not limited to.

As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

The present disclosure will now be described more fully hereinafter with reference to the accompanying drawings, in which embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout.

This disclosure is directed to a management computer to manage one or more managed computer nodes in multiple platforms by using only an Android Smartphone, a management device such as a baseboard management controller and a management firmware instance to perform management functions to the one or more managed computer nodes in multiple platforms.

Referring to FIG. 1, a conceptual illustration of a networked computer system 100 is shown according to one embodiment of the present disclosure. The networked computer system 100 includes, a handheld computing device 102, a managed computer system 103 including a management device 120, and managed computer nodes 124-1, 124-2, . . . , and 124-N. In certain embodiments, the management device 120 can be a Baseboard Management Controller (BMC), and the computer nodes can be computer boards or blade servers plugged onto a back plane in a chassis 140. The management device 120 communicatively connected to the managed computer nodes 124-1, 124-2, . . . , and 124-N. The management device 120 may be a general purpose computer system. It should be appreciated that the management device 120 may alternatively be a “special purpose” computer system or a system that incorporates more than one interconnected system, such as a client-server network. Indeed, the management device 120 of FIG. 1 only represents an exemplary embodiment of the present disclosure, and therefore, should not be considered to limit the disclosure in any manner. A BMC will now be used in the description as an example of the management device 120. One skilled in the art would appreciate that other similar devices can be used in place of the BMC 120. The BMC 120 includes a processor 127, firmware 121 stored in memory 123, and network interface controller 122.

Intelligent Platform Management Interface (“IPMI”) is an industry standard for system monitoring and event recovery. The IPMI specification provides a common message-based interface for accessing all of the manageable features in a compatible computer. IPMI includes a rich set of predefined commands for reading temperature, voltage, fan speed, chassis intrusion, and other parameters. System event logs, hardware watchdogs, and power control can also be accessed through IPMI. In this manner, IPMI defines protocols for accessing the various parameters collected by a BMC 120 through an operating system or through an external connection, such as through a network or serial connection. Additional details regarding IPMI can be found in the IPMI Specification (Version 2.0), which is publicly available from INTEL CORPORATION, and which is incorporated herein by reference.

IPMI uses message-based interfaces for the different interfaces to the platform management subsystem such as IPMB, serial/modem, LAN, ICMB, PCI Management Bus, and the system software-side “System Interface” to the BMC 120.

All IPMI messages share the same fields in the message ‘payload’—regardless of the interface (transport) that they're transferred over. The same core of IPMI messages is available over every IPMI-specified interface, they are just ‘wrapped’ differently according to the needs of the particular transport. This enables a piece of management software that works on one interface to be converted to use a different interface mainly by changing the underlying ‘driver’ for the particular transport.

IPMI messaging uses a request/response protocol. IPMI request messages are commonly referred to as commands. The use of a request/response protocol facilitates the transfer of IPMI messages over different transports. It also facilitates multi-master operation on busses like the IPMB and ICMB, allowing messages to be interleaved and multiple management controllers to directly intercommunicate on the bus.

IPMI commands are grouped into functional command sets, using a field called the Network Function Code. There are command sets for sensor and event related commands, chassis commands, etc. This functional grouping makes it easier to organize and manage the assignment and allocation of command values.

All IPMI request messages have a Network Function, command, and optional data fields. All IPMI response messages carry Network Function, command, optional data, and a completion code field. As inferred earlier, the differences between the different interfaces has to do with the framing and protocols used to transfer this payload. For example, the IPMB protocol adds fields for I²C and controller addressing, and data integrity checking and handling, whereas the LAN interface adds formatting for sending IPMI messages as LAN packets.

The handheld computing device 102 includes an IPMI application 112 running on an operating system 110. In certain embodiments, the handheld computing device 102 is in communication with a wireless base station 104, which is connected with a telecommunication network 106. In certain embodiments, the handheld computing device 102 can be in communication with the management station 120 through BLUETOOTH, ZIGBEE, and/or WIFI network 109. The telecommunication network 106, through another computer network 108 such as LAN/WAN/Internet, is in communication with the managed computer system 103. Thus, the IPMI application 112 on the handheld computing device 102 can construct an IPMI message and send the message to the managed computer system 103 through the telecommunication network 106 and the computer network 108 in order to perform a management action or operation on the managed computer system 103. The IPMI message may include, among other things: (1) the source IP/MAC address, (2) a session ID, (3) a sequence number, (4) a Responder's Address, (5) the Responder's Logic Unit Number (LUN), (6) a Requester's Address, (7) the Requester's LUN, (8) command CMD, and (9) a message Channel number. In certain embodiments, the IPMI message may also include encapsulated data for IPMB request. The encapsulated data for IPMB request may include: (1) the Responder's Address, (2) the Responder's LUN, (3) the Requester's Address, (4) the Requester's LUN, (5) the command CMD, e.g., Get Sensor Reading, and (6) the sensor number.

The management device 120 includes a network interface controller 122 that is in communication with the computer network 108. The management device 120 also includes a processor 127 and a memory 123 having firmware stored on it. When the firmware 121 is executed by the processor 127, the firmware 121 can initiate a management instance 140, such as an IPMI software stack or BMC software stack that performs management functions of the computer system 103. The firmware 121 includes one or more message interfaces 144 that can be utilized by the management instance to send and receive IPMI messages from different communication channels. The message interface 144 can include any system interface defined by the IPMI, i.e., keyboard controller style (“KCS”) interface, a system management interface chip (“SMIC”) interface, a block transfer (“BT”) interface, and SMBus System Interface (SSIF). The message interface 144 can also include a network interface such as an IPMI LAN interface.

In general, the management instance 140 monitors operation, performance, and health-related aspects associated with the managed computer node 124, such as the temperature of one or more components of the managed computer node 124, speed of rotational components (e.g., spindle motor, CPU Fan, etc.) within the system, the voltage across or applied to one or more components within the managed computer node 124, and the available or used capacity of memory devices within the managed computer node 124. The management instance 140 is communicatively connected to the one or more management devices such as IPM Device 166, Sensor Device 154, SDR Repository Device 150, SEL Device 158, FRU Inventory Device 168, Event Receiver Device 156, Event Generator Device 170, Application Device 164, PEF Device 160, Alert Processing Device 162, and Chassis Device 172 defined by IPMI. In one embodiment, these components include sensor devices 134 for measuring various operating and performance-related parameters within the managed computer node 124. The sensor devices 132, 154 may be either hardware or software based components configured or programmed to measure or detect one or more of the various operating and performance-related parameters. The management instance 140 may receive this information sensed by the sensors 132, 154 via a communication bus for analysis, and more particularly, for determination as to whether an “event” is occurring within the managed computer system 103. For example, like many electrical components, the CPU 130 dissipates heat while operating. As such, a CPU fan (not shown in FIG. 1) can be used to cool off the CPU 130 after the CPU 130 reaches a prescribed temperature. Such a determination, i.e., whether the CPU 130 exceeds a prescribed temperature, can be made by the management instance 140.

In certain embodiments, the management instance 140 is in communication with one or more managed computer nodes 124. For example, the management device 140 and the managed computer nodes 124 each can have an IPMB interface 134, 144 connected to an IPMB bus 146 and communicate with each other through the IPMB bus 146. A managed computer node 124 may have one or more management devices 132. Thus, the management instance 140 can communicate with the management devices 132 through the IPMB bus 146. Further, a managed computer node 124 may also have a satellite management controller 127. The management instance 130 can communicate with the satellite management controller through the IPMB bus.

FIG. 2 is a block diagram schematically showing the architecture of the handheld computing device 102. In certain embodiments, the handheld device is a smart phone or a tablet computer. The handheld computing 102 device can run various operating systems such as iOS, Android, and Microsoft Windows 8. From now the present disclosure will use Android system as an illustrative example. In certain embodiments, the handheld computing device 102 runs on Android operating system. The Android system utilizes a Linux kernel 214 to control the hardware 210. The Android runtime 218 such as Dalvik and Zygote is running on top of the linux kernel 214. On top of the Android runtime 218, several system servers or services 222 are provided by the Android operating system. For example, the database server 234 is provided. Further, Android namespace library 226 and Java namespace library 230 are provided on top of the Android runtime. The IPMI application 240 is running on top of the system services 222 and the Android and the Java libraries 226, 230. Further, different processes running on an Android system can use the Binder remote procedure call mechanism for inter-process communication.

In certain embodiments, the IPMI application 240 includes a data module 252, a user interface module 254, a message module 256, a network module 258, and a management module 242. Each of these modules may utilize the Android namespace and Java namespace APIs and libraries 226, 230.

The management module 242 provides the overall functionalities of an IPMI client and is in communication with the other modules. Various data structures can be used to transfer the information among the modules. In certain embodiments, the modules utilize one or more of the following APIs and libraries to transfer data among each other:

android.content.DialogInterface;

android.content.pm.PackageInfo;

android.content.pm.PackageManager.NameNotFoundException;

android.content.Intent;

android.content.DialogInterface.OnDismissListener;

android.content.ContentValues;

android.content.SharedPreferences; and

android.content.Context.

The user interface module 254 is responsible for generating a graphic user interface and display the interface on the display screen of the phone service. The user interface module is also responsible for receiving user inputs through the displayed interface. The user interface module can utilize various APIs and libraries provided by the Android operating system, including one or more of the following:

android.view.ContextMenu;

android.view.MenuItem;

android.view.View;

android.view.ContextMenu.ContextMenuInfo;

android.widget.AdapterView;

android.widget.ArrayAdapter;

android.widget.ImageView;

android.widget.ListView;

android.widget.TextView;

android.widget.AdapterView.OnItemClickListener;

android.view.Menu;

android.widget.AutoCompleteTextView;

android.widget.Button;

android.widget.EditText;

android.widget.Toast;

android.view.ViewGroup;

android.widget.BaseAdapter;

android.view.LayoutInflater;

android.widget.ProgressBar;

android.view.WindowManager;

android.widget.AbsListView; and

android.widget.AbsListView.OnScrollListener.

The data module 252 can be used by the management module or other modules to store application data or user information. In certain embodiments, the data module is also in communication with the database 234 provided by the Android system. The data module 252 can optionally choose to save certain data in the database. In order to communicate with the database 234 and to perform data management functions, the data module 234 may use one or more of the following APIs and libraries:

android.database.Cursor;

android.database.sqlite.SQLiteDatabase;

android.database.sqlite.SQLiteException; and

android.database.sqlite.SQLiteOpenHelper;

The message module 256 is responsible for constructing IPMI messages under the instruction of the management module.

The network module 258 is responsible for constructing network packets to encapsulate the IPMI messages constructed by the message module and then transmit the network packets to the network. The network module 258 may utilize one or more of the following APIs and libraries:

java.net.DatagramPacket;

java.net.InetSocketAddress;

java.net.DatagramSocket;

java.net.SocketException;

java.nio.ByteBuffer;

java.nio.ByteOrder;

java.nio.channels.DatagramChannel;

java.nio.channels.SelectionKey;

java.nio.channels.Selector; and

java.util.Iterator.

In certain embodiments, upon a user launches the IPMI application 240 on the handheld computing device 102, the management module 242 of the IPMI application 240 instructs the user interface module 254 to generate a connection interface and the display in the interface on the screen. FIG. 3A shows an exemplary connection interface. In this example, the interface has fields 310, 312, 314 for a user to input the network address (e.g. IP address) of a target BMC, a username, and a password. After the user inputs the requested information, he may click a “Connect” button 320 to submit the information, thus requesting the IPMI application 240 to establish a communication channel with the target BMC 120. The user interface module 254, accordingly, receives the submitted information including the network address of the BMC, the user name, and the password and then transmits the received information to the management module 242. Alternatively, the user may input the hostname of the target BMC 120. The IPMI application 240, after receiving the hostname, can use various naming systems, e.g., Network Information Service (NIS), Domain Name System (DNS), and Server Message Block (SMB), to determine the network address of the target BMC 120.

Further, the target BMC 120 may be a UPnP device in a UPnP network. The target BMC 120 can identify itself in descriptions of UPnP/SSDP messages sent by the target BMC 120. Thus, the IPMI application 240 can filter the UPnP/SSDP messages in the network and discover the target BMC 120 based on the descriptions.

The management module 242, after receiving the user submitted information, may optionally save the BMC network address and/or the username in the data module 252. The data module 252, in turn, may choose to save the information in the database server 234 provided by the Android system. By doing so, next time when the user launches the IPMI application, the management module 242 can retrieve the information such as the BMC network address and the user name from the data module (which may need to locate the records from the database 234 of the Android system) and pass the information to the user interface module 254. Therefore, when the user interface module 254 generates the connection interface 300, it may provide the saved information as default input and the show it in the interface 300. This provides convenience to the user and eliminates the need for manually inputting the same BMC network address and username by the user each time.

As an example, specific BMC IP addresses can be chosen from a pull down menu 322. Further, FIG. 3B illustrates that, in certain embodiments, when the user touches the screen of username and password field 312, 314, a touch screen soft keyboard 350 may show up to allow the user to enter the username and password. Optionally, the interface 300 may display a “SAVE USERNAME” button 326 that allows a user to request saving the username in the IPMI application 240.

Once the management module 242 receives the BMC network address, the user name, and the password, the management module 242 selects an appropriate IPMI message for making a connection with the target BMC 120. For example, in order to establish a session with the BMC 120, the management module 242 can select a Get Session Challenge command and an Activate Session Command. The management module 242 then can pass the username and password information to the message module 256 and instructs the message module 256 to construct a Get Session Challenge command and subsequently an Activate Session Command.

The message module 256, after receiving the indication of an IPMI message to be constructed and the data or parameters to be included in the IPMI message, will accordingly construct the IPMI message as instructed by the management module. An exemplary IMPI request includes one or more of: the source IP/MAC address, the Responder's Address, the Network function code, the Responder's LUN, the Requester's Address, the Requester's LUN, and the command. In certain embodiments, the IPMI message can also include a message Channel number for example indicating IPMB, encapsulated data for IPMB request. The encapsulated data for IPMB request includes one or more of: the Responder's slave address, the Responder's LUN, the Requester's slave address, the Requester's LUN, the command, e.g., Get Sensor Reading, and the Sensor Number. As an example, the message module 256 constructs the requested IPMI message as a string of binary bits and then returns the string to the management module 242.

The management module 256, after receiving the constructed IPMI message from the message module 256, then sends the BMC's network address and the IPMI message to the network module 258. The network module 258 encapsulates the IPMI message in one or more network packets addressed to the BMC's network address. In certain embodiments, the network module encapsulates the IPMI message in a java.nio.ByteBuffer. After constructing the network packets, the network module can utilize the network functions provided by the Android system to transmit the network packets to the network 108. In certain embodiments, the network module uses the Send method of DatagramChannel.

The network module 258, on the other hand, also receives network packets addressed to the IPMI application 240 and transferred by the Android system. For example, after the BMC 120 receives the network packets encapsulating the get session challenge command sent from the handheld computing device 102, the BMC 120 will send an IPMI response, including for example challenge string data, back to the handheld computing device 102. The network module 258 can extract the IPMI response from the network packets. Then, the network module 258 transfers the IPMI response, for example as a string of binary bits, to the management module 242.

The management module 242 after receiving the IPMI response will pass the response to the message module 256. The message module 256 can examine or parse the response, and then determines the type of the response and parameters/data contained in the response. For example, the message module 256 can determine that the response is a response to the Get Session Challenge command and then extract the data field to retrieve the Challenge String Data. The message module 242 then can call functions of the management module 242 to pass information extracted and interpreted from the IPMI response.

In this example, the management module 242 receives response of the session request information from the message module 256 and then executes other operations in order to establish a connection with the target BMC. For example, the management module 240 can send necessary information to the message module 256 and instruct the message module 256 to construct a selected session command. After receiving the session command from the message module 256, the management module 240 can transfer of the session command and the BMC address to the network module 258, and then request the network module 258 to encapsulate the session command in network packets addressed to the BMC 120 and send the packets to the network 108. Subsequently, the management module 242 establishes a session over a communication channel (such as a LAN channel) with the management instance 140 of the BMC 120.

After a session is established, the management module 242 then instructs the user interface module 254 to generate a functions selection interface and display the interface to the user. FIG. 4 shows an exemplary functions selection interface 400. In this example, the available management functions include: Power management 410, Sensor management 412, System Event Log (SEL) management 414, Field Replaceable Unit (FRU) management 416, and Raw Command management 418.

The user may choose one of the management functions and click the corresponding button to instruct the IPMI application 240 to perform the selected management function. For example, when the user selects power management 410, the user interface module 254 receives a user input indicating this selection, and sends this information to the management module 242. Accordingly, the management module 242 will instruct the user interface module 254 to generate a power management interface. FIG. 5 shows an exemplary power management interface 500.

For example, the status of the system power of the managed computer systems can be shown at the top of the screen. In this example, the power of the managed computer node is “ON”. The power management interface 500 displays one or more of power management actions or operations. For example, the actions or operations can include one or more of the following: Power Off 510 turning off a managed computer node; Power On 512 turning on the managed computer node; Power Cycle 514 turning off and then turning on the managed computer node; Reset 516 which is equivalent to remotely pressing “Reset” button on the managed computer node; NMI 518 performing a non-maskable Interrupt to handle non-recoverable hardware errors; and Soft Off 520 putting the managed computer 103 on a standby mode.

The user interface module 254 receives a user selection of the power management action and sends the user input to the management module 242. The management module 242 then determines an appropriate IPMI command and parameters based on the user input, and instructs the message module 256 to construct the determined IPMI command including relevant the data. The management module 242 then instructs the network module 258 to encapsulate the IPMI command and transmits the network packets to the BMC 120.

Further, the user may select functions for retrieving data from the BMC at the functions selection interface 400. For example, the user may select the Sensors 412, SEL 414, or FRU 416 management. For these functions, the management module similarly will use the message module 256 to generate a corresponding IPMI commands and then use the network module 258 to transmit the commands to the BMC 120. The BMC 120, in response, will send IPMI responses with the requested data. The responses are encapsulated in network packets and transferred to the network module 258 by the Android system. The management module 242, similarly as described above, receives the responses from the network module 258 and then instructs the message module 256 to retrieve the requested data. After receiving the requested data from the message module 256, the management module 256 will instruct the user interface module 254 to generate a data display interface to display the requested data. For example, when the user selects the “Sensors” Option in FIG. 4, the user interface module 254, will be instructed by the management module 242, to generate a sensor data display interface to display the requested sensor data. FIG. 6A shows an exemplary sensor data display interface 600. For example, all sensors readings of the managed computer node can be displayed in a list. In one embodiment, the display interface provides one or more mechanism to display amount of data in a screen having a limited size. For example, the number of sensors may be 10. But there may be only enough room on the screen to display sensors 1 through 6. When the user swaps the screen or uses the sliding bar on the right of the screen, other sensors such as sensors 7 through 10 will be displayed. As one example, where a sensor is a fan speed sensor, the RPM of the fan can be displayed in an entry. Where a sensor is a temperature sensor, the temperature reading of the sensor can be displayed in an entry.

In certain embodiments, the user interface module 254 can also utilize a detail display interface to display detailed data of a particular sensor or device. FIG. 6B illustrates an exemplary detail display interface 650. For example, when the user selects one of the sensors by touching the specific sensor listed on the screen, the management module accordingly obtains detailed data, e.g., through a Get Sensor Reading command, for the selected sensor device, and then instruct the user interface module 254 to generate the detailed display interface 650 to display those data.

As an example, when the user selects the “SEL” Option in FIG. 4, the management module 242 may instruct the user interface module 254 to generate a system event log screen 700 as illustrated in FIG. 7 according to certain embodiments of the present disclosure. Any or all of the management events relating to the managed computer node can be listed in a list. When the user selects one of the events by touching the specific event listed on the screen, another screen will be displayed to show the detail information of the system even selected. The system event log can be sorted in several different ways. For example, in one embodiment, the system event log can be sorted by the time these events occurred. In another embodiment, the system event log can be sorted by levels of the events.

As an example, when the user selects the “FRU” Option in FIG. 4, the management module 242 may instruct the user interface module 254 to generate a Field Replaceable Unit (FRU) screen 800 as illustrated in FIG. 8 according to certain embodiments of the present disclosure. Any or all FRUs relating to the managed computer node can be listed in a list. The user may select one of the FRUs by touching the specific FRU listed on the screen. Another screen will be displayed to show the detail information of the FRU selected. In one embodiment, the detailed information include: name, model number, serial number, manufacture date, manufacturer, vendor, specifications, control number, etc.

In certain embodiments, upon retrieving the management data, such as sensor data or event data, requested by a user, in addition to displaying the data to the user as described above, the management module 242 can transfer the data to the data module and instruct the data module to store those data in the IPMI application 240 itself or in the database provided by the Android system. In other words, the IPMI application 240 may optionally maintain cached copies of the management data. Those cached management data can be retrieved and displayed to a user when needed, for example, when the handheld computing device is not connected to a network.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. An IPMI remote management application, comprising:
an application program executed on a processor of a handheld device and configured to
display a first user interface on the handheld device;
receive a user input through the first user interface;
determine an IPMI request message and a target baseboard management controller (BMC) based on the user input; and
construct the request message and transmit the request message to the target BMC through a network.

2. The IPMI remote management application of claim 1, wherein the application program is configured to
encapsulate the request message in the at least one first network packet;
determine a network address of the target BMC; and
transmit the at least one first network packet to the network address through the network.

3. The IPMI remote management application of claim 1, wherein the application program is configured to
receive at least one second network packet encapsulating an IPMI response message;
extract the IPMI response message from the second network packets;
extract response data from the IPMI response message; and
display a second interface on the handheld device, the second interface having the response data.

4. The IPMI remote management application of claim 1, wherein the request message requests the target BMC to perform at least one management function on a computer system managed by the target BMC.

5. The IPMI remote management application of claim 4, wherein the request message requests the target BMC to perform a management function on at least one management device of the computer system.

6. The IPMI remote management application of claim 5, wherein the at least one management device includes at least one of: a IPM Device, a Sensor Device, a SDR Repository Device, a SEL Device, a FRU Inventory Device, an Event Receiver Device, an Event Generator Device, an Application Device 164, a PEF Device, an Alert Processing Device 162, and a Chassis Device.

7. The IPMI remote management application of claim 1, wherein the application program includes
a management module;
a user interface module;
a message module; and
a network module,
wherein the management module is configured to
obtain information of the user input from the user interface module;
determine the IPMI request message in accordance with the information;
retrieve the request data from the information;
instruct the message module to construct the IPMI request message with the request data;
obtain the constructed IPMI request message from the message module; and
transmit the constructed request message to the network module with a network address of the target BMC.

8. The IPMI remote management application of claim 7, wherein the user interface module is configured to
generate the first interface and display the first interface on the handheld device; and
receive the user input through the first interface.

9. The IPMI remote management application of claim 7, wherein the message module is configured to
receive a request indication and the request data; and
construct the IPMI request message containing the request data in accordance with the request indication.

10. The IPMI remote management application of claim 7, wherein the network module is configured to
receive the IPMI request message and a first network address;
encapsulate the IPMI request message in at least one first network packet addressed to a first network address; and
transmit the at least one first network packet to a network,

11. The IPMI remote management application of claim 7, wherein the network module is configured to receive at least one second network packet encapsulating an IPMI response message; extract the IPMI response message from the second network packet; and send the IPMI response message to the management module, wherein the management module is configured to send the response message to the message module to extract response data and send the response data to the user interface module and; wherein the user interface module is configured to display a second user interface having the response data.

12. The IPMI remote management application of claim 10, wherein the application program includes a data module, wherein the data module is configured to
receive record data; and
store the record data in a storage area of the data module.

13. The IPMI remote management application of claim 10, wherein the application program is running on an Android operating system.

14. A method of IPMI remote management, comprising:
displaying a first user interface of an application program on a handheld device;
receiving a user input through the first user interface;
determining an IPMI request message and a target baseboard management controller (BMC) based on the user input; and
constructing the request message at the application program and transmitting the request message to the target BMC through a network.

15. The method of claim 14, comprising:
encapsulating the request message in the at least one first network packet;
determining a network address of the target BMC;
transmitting the at least one first network packet to the network address through the network;
receiving at least one second network packet encapsulating an IPMI response message;
extracting the IPMI response message from the second network packets;
extracting response data from the IPMI response message; and
displaying a second interface on the handheld device, the second interface having the response data.

16. The method of claim 15, comprising:
at a management module configured to:
obtaining information of the user input from the user interface module;
determining the IPMI request message in accordance with the information;
retrieving the request data from the information;
instructing the message module to construct the IPMI request message with the request data;
obtaining the constructed IPMI request message from the message module; and
transmitting the constructed request message to the network module with a network address of the target BMC;
at a user interface module:
generating the first interface and displaying the first interface on the handheld device; and
receiving the user input through the first interface;
at a message module:
receiving a request indication and the request data; and
constructing the IPMI request message containing the request data in accordance with the request indication; and
at a network module:
receiving the IPMI request message and a first network address;
encapsulating the IPMI request message in at least one first network packet addressed to a first network address; and
transmitting the at least one first network packet to a network.

17. The method of claim 16, comprising:
at the network module:
receiving at least one second network packet encapsulating an IPMI response message;
extracting the IPMI response message from the second network packet; and
sending the IPMI response message to the management module,
wherein the management module is configured to
sending the response message to the message module to extract response data, and
sending the response data to the user interface module; and
at the user interface module:
displaying a second user interface having the response data.

18. A non-transitory computer storage medium having computer-executable instructions stored thereon which, when executed by a processor of a handheld device, cause the processor to
display a first user interface on the handheld device;
receive a user input through the first user interface;
determine an IPMI request message and a target baseboard management controller (BMC) based on the user input; and
construct the request message and transmit the request message to the target BMC through a network.

19. The non-transitory computer storage medium of claim 18, wherein the computer-executable instructions, when executed by the processor, cause the processor to
encapsulate the request message in the at least one first network packet;
determine a network address of the target BMC;
transmit the at least one first network packet to the network address through the network;
receive at least one second network packet encapsulating an IPMI response message;
extract the IPMI response message from the second network packets;
extract response data from the IPMI response message; and
display a second interface on the handheld device, the second interface having the response data.

20. The non-transitory computer storage medium of claim 19, wherein the computer-executable instructions comprises an application program, and the application program includes
a management module configured to:
obtain information of the user input from the user interface module;
determine the IPMI request message in accordance with the information;
retrieves the request data from the information;
instruct the message module to construct the IPMI request message with the request data;
obtain the constructed IPMI request message from the message module; and
transmit the constructed request message to the network module with a network address of the target BMC;
a user interface module configured to:
generate the first interface and display the first interface on the handheld device; and
receive the user input through the first interface.
a message module configured to:
receive a request indication and the request data; and
construct the IPMI request message containing the request data in accordance with the request indication; and
a network module configured to
receive the IPMI request message and a first network address;
encapsulate the IPMI request message in at least one first network packet addressed to a first network address; and
transmit the at least one first network packet to a network,
wherein the network module is configured to
receive at least one second network packet encapsulating an IPMI response message;
extract the IPMI response message from the second network packet; and
send the IPMI response message to the management module,
wherein the management module is configured to
send the response message to the message module to extract response data, and
send the response data to the user interface module; and
wherein the user interface module is configured to
display a second user interface having the response data.
